(19) United States
(12) Patent Application Publication
(10) Pub. No.: US 2009/0032587 A1
(43) Pub. Date: Feb. 5, 2009

(54) User identification system

(75) Inventor: Takako Takanashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/232,531

(22) Filed: Sep. 18, 2008

Related U.S. Application Data
(63) Continuation of application No. PCT/JP2006/306922, filed on Mar. 31, 2006.

(51) Int. Cl. G06K 5/00; G07B 15/04

(52) U.S. Cl. 235/382; 235/380; 705/13

(57) ABSTRACT

A user identification system includes a portable terminal device for holding user information for receiving a designated service and a user information inspection device for inspecting the user information, wherein provisions are made to prevent any person other than the rightful holder of the portable terminal device from receiving the service by using the portable terminal device. The user information inspection device acquires biometric data from the bearer of the portable terminal device when a designated part of his body is held over the inspection device, and transmits the acquired biometric data via radio directly to the portable terminal device passing in proximity to it. The portable terminal device receives the biometric data, compares it with prestored biometric data, and transmits the prestored user information via radio to the user information inspection device only when a data match is confirmed. Based on the received user information, the user information inspection device permits use by the bearer of the portable terminal device.

### CROSS-REFERENCE TO RELATED APPLICATIONS

This application is a continuation of PCT/JP2006/306922, filed on Mar. 31, 2006, the contents are incorporated herein by reference.

### TECHNICAL FIELD

The present invention relates to a system that comprises a portable terminal device for holding user information for receiving a designated service and a user information inspection device for inspecting the user information, and identifies whether the user is an authorized user.

### BACKGROUND ART

IC cards, a form of electronic card in which an IC chip is embedded, are widely used. In recent years, not only contact IC cards, but also contactless IC cards have been finding widespread use. The contactless IC card is an IC card whose embedded IC chip operates by electromagnetic waves transmitted from a reader/writer and performs data communication with the reader/writer, and is used, for example, at automated railway ticket gates.

Recent years have also seen the introduction of portable telephones equipped with contactless IC chips. Portable telephones equipped with contactless IC chips are used, for example, for shopping at convenience stores, purchasing drinks from automatic vending machines, paying entrance fees, etc. Further, portable telephones equipped with contactless IC chips in which commuter pass information is stored have recently come to be used at automated railway ticket gates.

However, this, has the problem that any person other than the rightful holder of a portable telephone can pass through an automated ticket gate by using the portable telephone. To solve this problem, a system is proposed that verifies the identity of the user by using personal biometric information such as fingerprint information, but this involves a problem from the standpoint of personal information protection since the personal biometric information needs to be preregistered with the system.

Patent document 1 cited below as a prior art document related to the present invention discloses a fingerprint matching ticket gate system comprising: a fingerprint matching ticket gate machine equipped with a fingerprint detector and a gate that opens and closes; a passenger database for storing fingerprint feature data pertaining to commuter pass users who can pass through the gate; and a control means for matching the fingerprint feature data detected by the fingerprint detector against the fingerprint feature data stored in the passenger database and for outputting an open signal to the gate if matching fingerprint feature data is found.

On the other hand, patent document 2 cited below discloses a portable terminal device in which first personal identification information and second personal identification information are stored, and in which data input from a personal information input device is compared with the first personal identification information to check whether the user is the rightful holder of the portable terminal device, with provisions made to enable the retrieval of the second personal identification information when the user is judged to be the rightful holder, but disable the retrieval of the second personal identification information if the user is judged not to be the rightful holder.

Patent document 1: Japanese Unexamined Patent Publication No. 2001-307144

Patent document 2: Japanese Unexamined Patent Publication No. 2003-101639

### DISCLOSURE OF THE INVENTION

### Problem to be Solved by the Invention

The present invention has been devised in view of the above problem, and an object of the invention is to provide a user identification system comprising a portable terminal device for holding user information for receiving a designated service and a user information inspection device for inspecting the user information, wherein provisions are made to prevent any person other than the rightful holder of the portable terminal device from receiving the service by using the portable terminal device.

### Means for Solving the Problem

To achieve the above object, according to the present invention, a user identification system is provided comprising a portable terminal device for holding user information for receiving a designated service and a user information inspection device for inspecting the user information, wherein the portable terminal device comprises: biometric data storing unit for storing biometric data pertaining to a holder of the portable terminal device; user information storing unit for storing user information pertaining to the holder; biometric data receiving unit for receiving biometric data transmitted via radio from the user information inspection device; biometric data comparing unit for comparing the biometric data received by the biometric data receiving unit with the biometric data stored in the biometric data storing unit; and user information transmitting unit for transmitting via radio the user information stored in the user information storing unit to the user information inspection device only when a data match is confirmed by the biometric data comparing unit, and the user information inspection device comprises: biometric data acquiring unit for acquiring biometric data from a bearer of the portable terminal device when a designated part of the bearer's body is held over the acquiring unit; biometric data transmitting unit for transmitting via radio the biometric data acquired by the biometric data acquiring unit to the portable terminal device passing in proximity to the transmitting unit; and a use permitting unit for permitting use by the bearer of the portable terminal device, based on the user information received via radio from the portable terminal device.

In one preferred mode, the portable terminal device is a portable telephone, the user information inspection device is an automated railway ticket gate machine, and the user information is commuter pass information.

According to the present invention, a portable terminal device is provided for holding user information for receiving a designated service, comprising: biometric data storing unit for storing biometric data pertaining to a holder of the portable terminal device; user information storing unit for storing user information pertaining to the holder; biometric data receiving unit for receiving biometric data transmitted via radio from a user information inspection device; biometric data comparing unit for comparing the biometric data received by the biometric data receiving unit with the biometric data stored in the biometric data storing unit; and user information transmitting unit for transmitting via radio the user information stored in the user information storing unit to the user information inspection device only when a data match is confirmed by the biometric data comparing unit.

According to the present invention, a user information inspection device is provided for inspecting user information, comprising: biometric data acquiring unit for acquiring biometric data from a bearer of a portable terminal device when a designated part of the bearer's body is held over the acquiring unit; biometric data transmitting unit for transmitting via radio the biometric data acquired by the biometric data acquiring unit to the portable terminal device passing in proximity to the transmitting unit; and use permitting unit for permitting use by the bearer of the portable terminal device, based on the user information received via radio from the portable terminal device.

According to the present invention, a user identification method is also provided for use in a user identification system comprising a portable terminal device for holding user information for receiving a designated service and a user information inspection device for inspecting the user information, the method comprising: causing the user information inspection device to acquire biometric data from a bearer of the portable terminal device when a designated part of the bearer's body is held over the inspection device; causing the user information inspection device to transmit the acquired biometric data via radio to the portable terminal device passing in proximity to the inspection device; causing the portable terminal device to receive the biometric data transmitted via radio from the user information inspection device; causing the portable terminal device to compare the received biometric data with prestored biometric data; causing the portable terminal device to transmit via radio the user information prestored therein to the user information inspection device only when a data match is confirmed in the comparing step; and causing the user information inspection device to permit use by the bearer of the portable terminal device, based on the user information received via radio from the portable terminal device.

### Effect of the Invention

According to the user identification system of the present invention, if any person other than the rightful holder of the portable terminal device in which user information for receiving a designated service is stored tries to use the portable terminal device, the user information is not transmitted to the user information inspection device, thus reliably preventing such a person from receiving the service. In this system, the biometric data as personal information need not be preregistered with the user information inspection device.

### BRIEF DESCRIPTION OF THE INVENTION

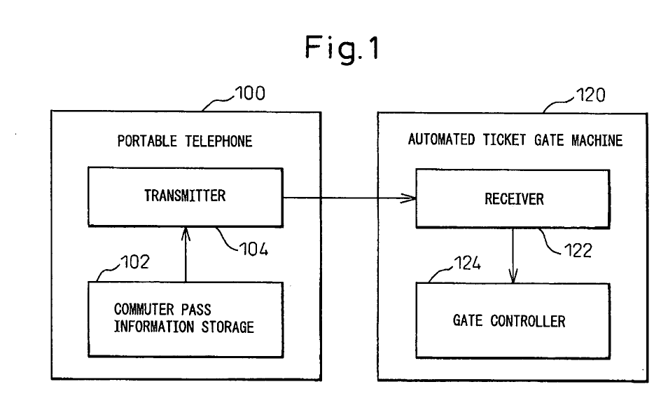

FIG. 1 is a diagram showing the configuration of an automated railway ticket gate system according to the prior art.

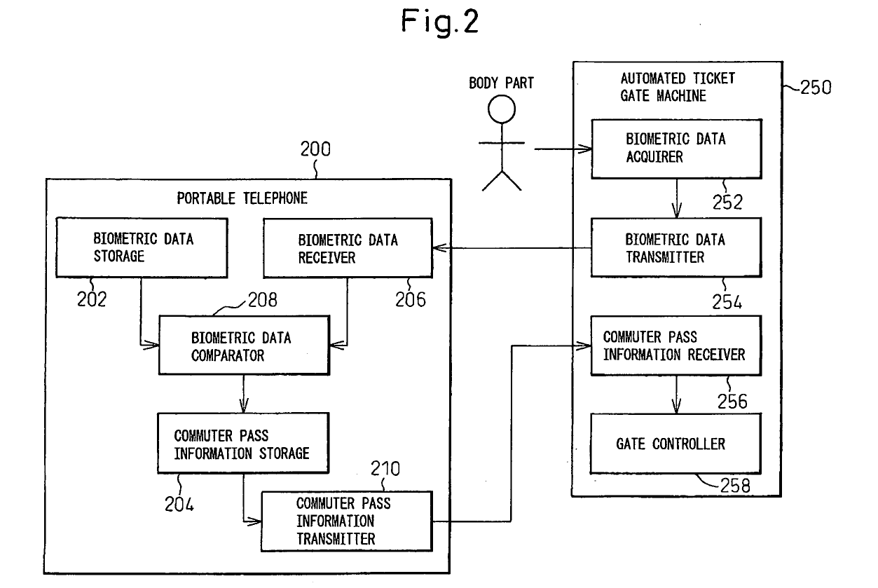

FIG. 2 is a diagram showing the configuration of an automated railway ticket gate system as one embodiment of a user identification system according to the present invention.

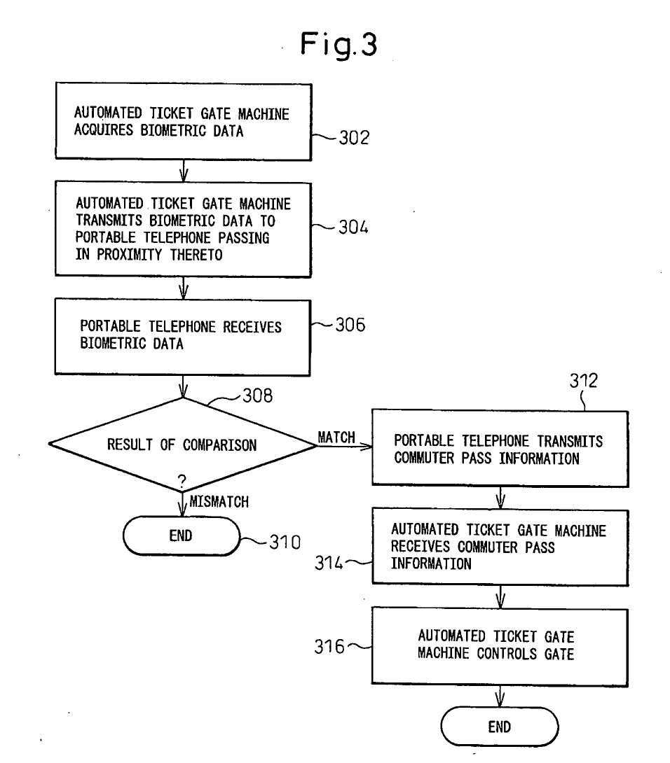

FIG. 3 is a flowchart illustrating the operation of the automated railway ticket gate system shown in FIG. 2.

### DESCRIPTION OF THE REFERENCE NUMERALS

100. PORTABLE TERMINAL
102. COMMUTER PASS STORAGE
104. TRANSMITTER
120. AUTOMATED TICKET GATE MACHINE
124. GATE CONTROLLER
200. PORTABLE TELEPHONE
202. BIOMETRIC DATA STORAGE
204. COMMUTER PASS INFORMATION STORAGE
206. BIOMETRIC DATA RECEIVER
208. BIOMETRIC DATA COMPARATOR
210. COMMUTER PASS INFORMATION TRANSMITTER
250. AUTOMATED TICKET GATE MACHINE
252. BIOMETRIC DATA ACQUIRER
254. BIOMETRIC DATA TRANSMITTER
256. COMMUTER PASS INFORMATION RECEIVER
258. GATE CONTROLLER

### BEST MODE FOR CARRYING OUT THE INVENTION

An automated railway ticket gate system as one embodiment of a user identification system according to the present invention will be described below with reference to the accompanying drawings. First, a description will be given of a prior art automated railway ticket gate system with reference to FIG. 1. A passenger who wants to pass through an automated ticket gate carries a portable telephone 100 as a portable terminal device. The portable telephone 100 comprises a commuter pass information storage 102 for storing commuter pass information and a transmitter 104 for transmitting the commuter pass information. The commuter pass information storage 102 and the transmitter 104 are implemented on a contactless IC chip.

The automated ticket gate machine 120 comprises a receiver 122 for receiving the commuter pass information and a gate controller 124 for controlling the opening and closing of the gate based on the commuter pass information. The receiver 122 is constructed as a reader/writer for the contactless IC chip. When the bearer of the portable telephone 100 holds the portable telephone 100 over the receiver 122, the receiver 122 radiates an electromagnetic wave, causing the IC chip in the portable telephone 100 to operate, and receives the commuter pass information by performing data communication with the transmitter 104 of the portable telephone 100.

However, as previously described, such a prior art system has the problem that any person other than the rightful holder of the portable telephone 100 can pass through the automated ticket gate by using the portable telephone 100. The present invention prevents unauthorized use of the portable telephone, as will be described below.

FIG. 2 is a diagram showing the configuration of the automated railway ticket gate system as one embodiment of the user identification system according to the present invention. In the figure, the portable telephone 200 as the portable terminal device comprises: a biometric data storage 202 for storing biometric data pertaining to the holder of the telephone; a commuter pass information storage 204 for storing commuter pass information as user information pertaining to the holder; a biometric data receiver 206 for receiving biometric data transmitted via radio from an automated ticket gate machine; a biometric data comparator 208 for comparing the biometric data received by the biometric data receiver 206 with the biometric data stored in the biometric data storage 202; and a commuter pass information transmitter 210 for transmitting via radio the commuter pass information stored in the commuter pass information storage 204 to the automated ticket gate machine only when a data match is confirmed by the biometric data comparator 208.

The automated ticket gate machine 250 as the user information inspection device comprises: a biometric data acquirer 252 for acquiring biometric data from the bearer of the portable telephone when a designated part of his body, for example, a fingerprint or vein, is held over it; a biometric data transmitter 254 for transmitting via radio the biometric data acquired by the biometric data acquirer 252 to the portable telephone passing in proximity to it; a commuter pass information receiver 256 for receiving the commuter pass information transmitted via radio from the portable telephone; and a gate controller 258 for controlling the opening and closing of the gate based on the commuter pass information received by the commuter pass information receiver 256.

Next, the operation of the automated railway ticket gate system shown in FIG. 2 will be described with reference to the flowchart of FIG. 3. In the portable telephone 200, the biometric data pertaining to the holder of the telephone is prestored in the biometric data storage 202, while the commuter pass information pertaining to the holder of the telephone is prestored in the commuter pass information storage 204.

First, in step 302, the person carrying the portable telephone 200 holds a designated part of his body, such as a fingerprint or vein, over the biometric data acquirer 252 of the automated ticket gate machine 250 when he passes through the automated ticket gate. The biometric data acquirer 252 acquires biometric data from the body part thus held over it.

Next, in step 304, the biometric data transmitter 254 of the automated ticket gate machine 250 transmits the biometric data acquired by the biometric data acquirer 252 to the portable telephone passing in proximity to it. In this communication, the communication distance is only a few meters, and therefore, a short-range radio link is used.

In step 306, the transmitted biometric data is received by the biometric data receiver 206 in the portable telephone 200 carried by the person from whom the biometric data was acquired.

Next, in step 308, the biometric data comparator 208 in the portable telephone 200 compares the biometric data received by the biometric data receiver 206 with the biometric data prestored in the biometric data storage 202, and thereby determines whether the received biometric data matches the biometric data pertaining to the holder of the portable telephone.

If the result of the comparison in step 308 indicates a mismatch, that is, if it is determined that the received biometric data does not match the biometric data pertaining to the holder of the portable telephone, the process proceeds to step 310 where the process is terminated.

On the other hand, if the result of the comparison in step 308 indicates a match, that is, if it is determined that the received biometric data matches the biometric data pertaining to the holder of the portable telephone, the process proceeds to step 312. In step 312, the commuter pass information transmitter 210 of the portable telephone 200 transmits via radio the commuter pass information stored in the commuter pass information storage 204 to the automated ticket gate machine 250. In this case, since the communication between the portable telephone 200 and the automated ticket gate machine 250 is performed using a short-range radio link, the user need not take out the portable telephone 200 from his bag or the like.

Next, in step 314, the thus transmitted commuter pass information is received by the commuter pass information receiver 256 in the automated ticket gate machine 250. Then, in step 316, the gate controller 258 controls the opening and closing of the gate based on the received commuter pass information, as in the prior art system.

In this way, in the above-described embodiment, the user need only hold the designated part of his body over the automated ticket gate machine, and need not take out the portable telephone from his bag or the like. Further, the biometric data for authenticating the user identity need only be stored in the user's portable telephone, and need not be preregistered with the automated ticket gate system.

The user identification system of the present invention has been described above by taking an automated railway ticket gate system as an example, but it will be appreciated that the present invention is not limited to this particular kind of system. For example, the present invention can also be applied to a ticket gate for controlling admittance by means of an admission ticket. In that case, instead of the commuter pass information, ticket information is stored in the portable telephone.

Furthermore, the present invention is applicable to automated cash handling machines such as cash dispensers (CDs) or automated teller machines (ATMs) installed in financial institutions such as banks. In that case, instead of the commuter pass information, cash card information is stored in the portable telephone.

What is claimed is:

1. A user identification system comprising a portable terminal device for holding user information for receiving a designated service and a user information inspection device for inspecting said user information, wherein
said portable terminal device comprises:
biometric data storing unit for storing biometric data pertaining to a holder of said portable terminal device;
user information storing unit for storing user information pertaining to said holder;
biometric data receiving unit for receiving biometric data transmitted via radio from said user information inspection device;
biometric data comparing unit for comparing the biometric data received by said biometric data receiving unit with the biometric data stored in said biometric data storing unit; and
user information transmitting unit for transmitting via radio the user information stored in said user information storing unit to said user information inspection device only when a data match is confirmed by said biometric data comparing unit, and
said user information inspection device comprises:
biometric data acquiring unit for acquiring biometric data from a bearer of said portable terminal device when a designated part of said bearer's body is held over said acquiring unit;
biometric data transmitting unit for transmitting via radio the biometric data acquired by said biometric data acquiring unit to said portable terminal device passing in proximity to said transmitting unit; and
use permitting unit for permitting use by the bearer of said portable terminal device, based on the user information received via radio from said portable terminal device.

2. A user identification system as claimed in claim 1, wherein said portable terminal device is a portable telephone, said user information inspection device is an automated railway ticket gate machine, and said user information is commuter pass information.

3. A portable terminal device for holding user information for receiving a designated service, comprising:
biometric data storing unit for storing biometric data pertaining to a holder of said portable terminal device;
user information storing unit for storing user information pertaining to said holder;
biometric data receiving unit for receiving biometric data transmitted via radio from a user information inspection device;
biometric data comparing unit for comparing the biometric data received by said biometric data receiving unit with the biometric data stored in said biometric data storing unit; and
user information transmitting unit for transmitting via radio the user information stored in said user information storing unit to said user information inspection device only when a data match is confirmed by said biometric data comparing unit.

4. A portable terminal device as claimed in claim 3, wherein said portable terminal device is a portable telephone, said user information inspection device is an automated railway ticket gate machine, and said user information is commuter pass information.

5. A user information inspection device for inspecting user information, comprising:
biometric data acquiring unit for acquiring biometric data from a bearer of a portable terminal device when a designated part of said bearer's body is held over said acquiring unit;
biometric data transmitting unit for transmitting via radio the biometric data acquired by said biometric data acquiring unit to said portable terminal device passing in proximity to said transmitting unit; and
use permitting unit for permitting use by the bearer of said portable terminal device, based on the user information received via radio from said portable terminal device.

6. A user information inspection device as claimed in claim 5, wherein said portable terminal device is a portable telephone, said user information inspection device is an automated railway ticket gate machine, and said user information is commuter pass information.

7. A user identification method for use in a user identification system comprising a portable terminal device for holding user information for receiving a designated service and a user information inspection device for inspecting said user information, said method comprising:
causing said user information inspection device to acquire biometric data from a bearer of said portable terminal device when a designated part of said bearer's body is held over said inspection device;
causing said user information inspection device to transmit said acquired biometric data via radio to said portable terminal device passing in proximity to said inspection device;
causing said portable terminal device to receive the biometric data transmitted via radio from said user information inspection device;
causing said portable terminal device to compare said received biometric data with prestored biometric data;
causing said portable terminal device to transmit via radio said user information prestored therein to said user information inspection device only when a data match is confirmed in said comparing step; and
causing said user information inspection device to permit use by the bearer of said portable terminal device, based on said user information received via radio from said portable terminal device.
